(19) United States
(12) Patent Application Publication
(10) Pub. No.: US 2012/0260252 A1
(43) Pub. Date: Oct. 11, 2012

(54) SCHEDULING SOFTWARE THREAD EXECUTION

(75) Inventors: JAMIE R. KUESEL, Rochester, MN (US); MARK G. KUPFERSCHMIDT, Rochester, MN (US); PAUL E. SCHARDT, Rochester, MN (US); ROBERT A. SHEARER, Rochester, MN (US)

(73) Assignee: INTERNATIONAL BUSINESS MACHINES CORPORATION, ARMONK, NY (US)

(21) Appl. No.: 13/082,578

(22) Filed: Apr. 8, 2011

(51) Int. Cl. G06F 9/46

(52) U.S. Cl. 718/102

(57) ABSTRACT

A computer-implemented method, system, and/or computer program product schedules execution of software threads. A first software thread is executed together with a second software thread as a first software thread pair. A first content, which resulted from executing the first software pair together, of at least one performance counter, is stored. The first software thread is then executed with a third software thread as a second software thread pair, and the resulting second content of the performance counter(s) is stored. An identification is made of a most efficient software thread pair from the first and second software thread pairs. Upon receiving a request to re-execute the first software thread, the first software thread is selectively matched with either the second software thread or the third software thread for execution based on whether the first software thread pair or the second software thread pair has been identified as the most efficient software thread pair.

### BACKGROUND

The present disclosure relates to the field of computers, and specifically to threaded computers. Still more particularly, the present disclosure relates to the scheduling of simultaneous execution of multiple threads.

A software program can be split up into multiple software threads, each of which is a small unit of processing that can be scheduled for execution on a particular processor, a particular processor core within a processor, and/or a particular hardware thread within a processor core. Most processors/cores can execute multiple software threads simultaneously. However, if the scheduling of such executions is not done with care, then two software threads can attempt to access a same resource at a same time, resulting in a degradation in execution efficiency, since one of the software threads must wait for the other software thread to finish using the shared resource before executing.

### BRIEF SUMMARY

A computer-implemented method, system, and/or computer program product schedules execution of software threads. A first software thread is executed together with a second software thread as a first software thread pair. A first content of at least one performance counter, which resulted from executing the first software pair together, is stored. The first software thread is then executed with a third software thread as a second software thread pair, and the resulting second content of the performance counter(s) is stored. An identification is made as to the most efficient software thread pair from the first and second software thread pairs. Upon receiving a request to re-execute the first software thread, the first software thread is selectively matched with either the second software thread or the third software thread for execution based on whether the first software thread pair or the second software thread pair has been identified as the most efficient software thread pair.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a high-level depiction of an exemplary Network On a Chip (NOC) as contemplated for use by the present invention;

FIG. 2 illustrates additional detail of a core within a node on the NOC shown in FIG. 1;

FIG. 3 depicts an exemplary embodiment of a computer that utilizes one or more NOCs;

FIG. 4 illustrates additional detail of the one or more NOCs depicted in FIG. 3;

FIG. 5 depicts additional detail of an IP block node of the NOC shown in FIG. 4;

FIG. 6 illustrates additional detail of a processor core found at an IP block node of the NOC shown in FIG. 5;

FIG. 7 depicts another computer architecture that may be utilized by the present invention; and

FIG. 8 is a high level flow chart of exemplary steps taken by the present invention to manage the scheduling of software threads.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

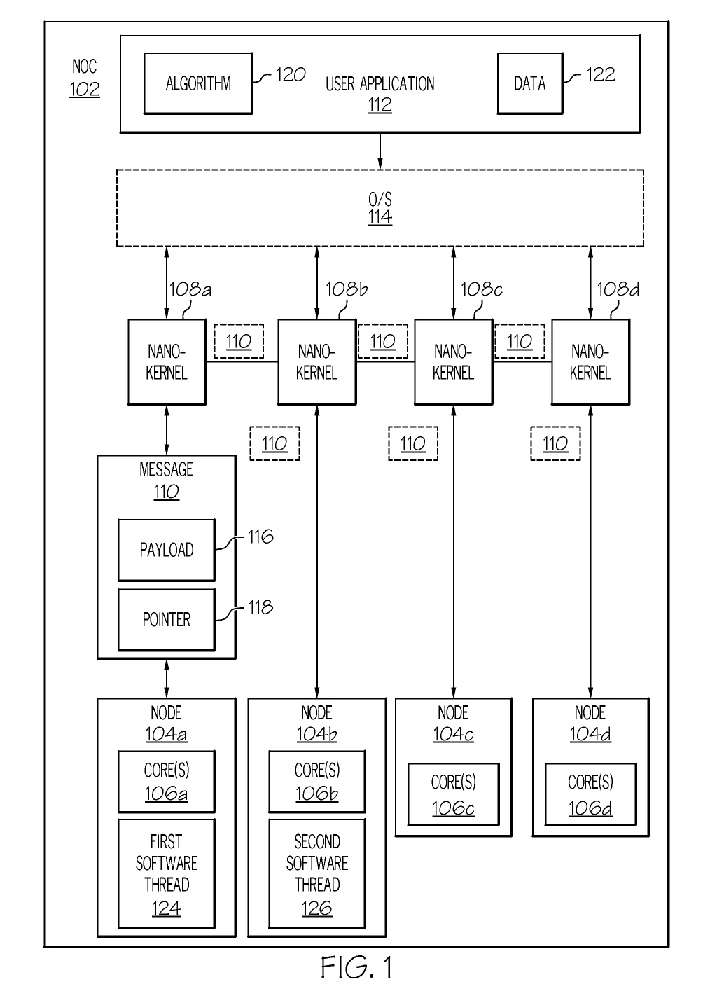

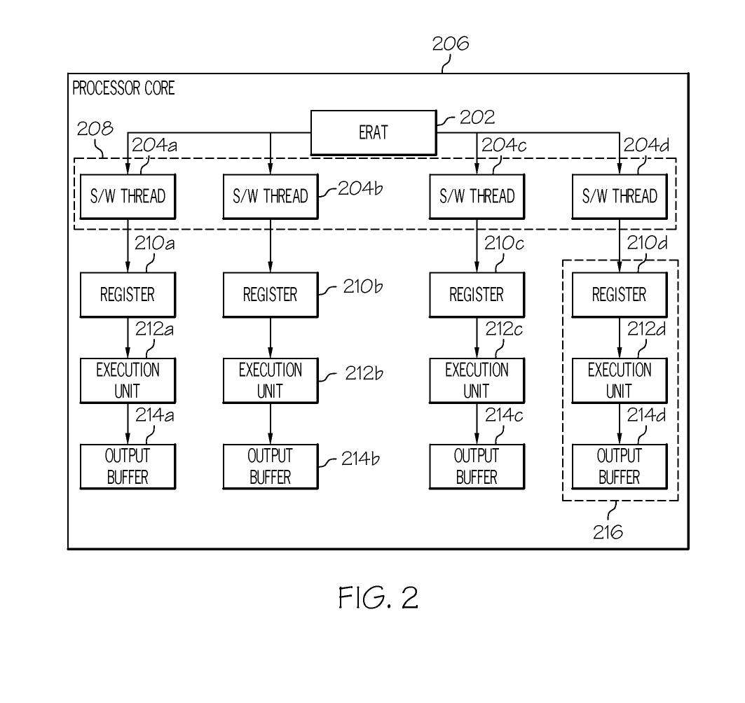

With reference now to the figures, and particularly to FIG. 1, an exemplary Network On a Chip (NOC) 102 is presented. NOC 102 comprises multiple nodes 104a-d (where “d” is an integer). Additional details for NOC 102 are presented below in FIGS. 2-6. Each of the multiple nodes 104a-d comprises at least one processor core (depicted as core(s) 106a-d). Each of the nodes 104a-d is associated with a nanokernel. Thus, each of the nodes 104a-d may utilize a different dedicated nanokernel (e.g., the depicted nanokernels 108a-d), or all of the nodes 104a-d may share a single nanokernel (not shown). A nanokernel is defined as software logic that manages software threads within a NOC by coordinating actions performed by nodes within the NOC. This coordination may be performed by invoking (e.g., pointing to) relevant algorithms and/or data for a particular software thread and/or user application, as well as coordinating compilation of an algorithm at run time. Thus, in an exemplary embodiment, a nanokernel is a thin piece of software logic that, by reading a message generated by a first software thread 124 from user application 112, is able to call an algorithm that is used by a second software thread 126 from the user application 112. Each software thread may be processed by a different node from nodes 104a-d, or software threads may be processed by different hardware threads within a single node selected from nodes 104a-d. Note that, in one embodiment, user application 112 can communicate with nodes 104a-d using a thin Operating System (O/S) 114, which includes a kernel that connects the user application 112 to the nanokernels 108a-d. In a preferred embodiment of the present invention, however, O/S 114 is bypassed (omitted), and the user application 112 directly communicates with nanokernels 108a-d.

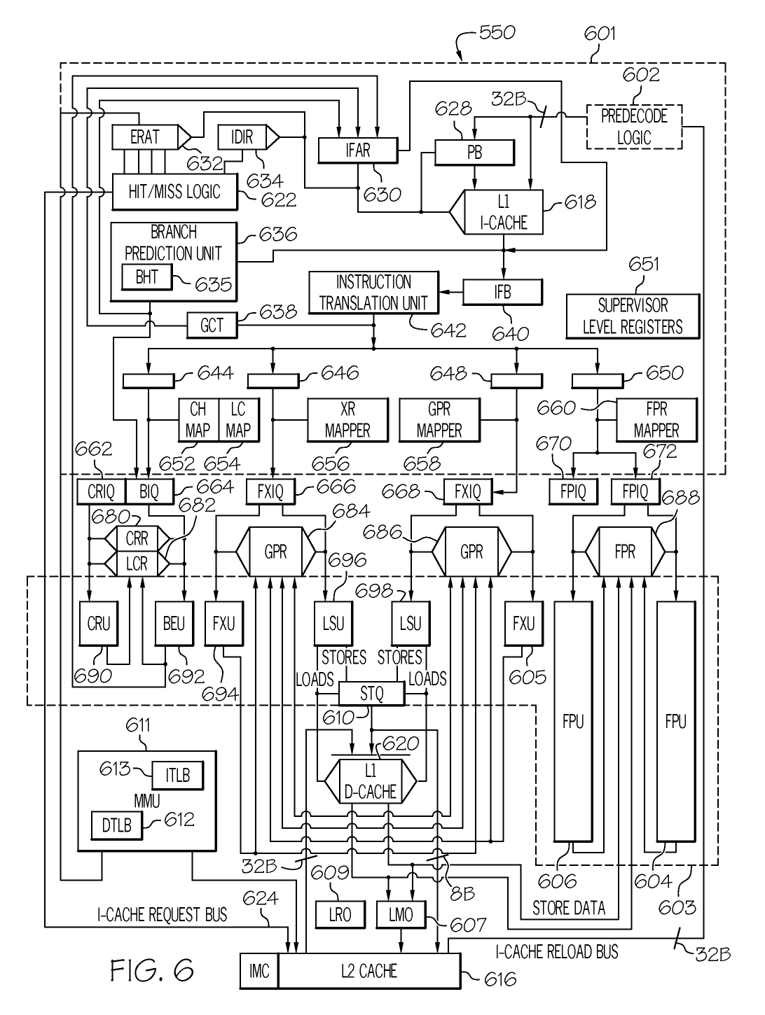

As noted above, each node (e.g., one of nodes 104a-d) includes one or more processor cores (e.g., one of processor core(s) 106a-d). Additional detail of an exemplary embodiment of such processor cores is presented as a processor core 206 in FIG. 2. Within processor core 206 is an Effective-to-Real Address Table (ERAT) 202 which is used to dispatch different software threads 204a-d from a work unit 208, which may be a user application (e.g., user application 112 shown in FIG. 1) or messages from nodes within the NOC, as described herein. When the work unit 208 is received by the processor core 206 (that is within the addressed node in the NOC), a specific hardware thread 216, made up of a register 210d, an execution unit 212d, and an output buffer 214d, will execute the instructions in the software thread 204d. With reference to FIG. 6 below, an exemplary hardware thread may be composed of FPR mapper 660, FPIQ 672, FPR 688 and FPU 604. Another exemplary hardware thread may be composed of GPR mapper 658, FXIQ 668, FXU 605, and GPR 686. These are exemplary hardware threads, as others may be contemplated that include FXU 694, LSU 698, CRU 690, BEU 692, etc.

Referring again to FIG. 2, note that in one embodiment, only hardware thread 216 may be allowed to execute execution of software thread 204d, while the other hardware threads (respectively composed of the other registers 210a-c, execution units 212a-c, and output buffers 214a-c) are frozen until software thread 204d completes execution.

Assume for purposes of illustration that first software thread 124 creates a wireframe for an object such as a piece of fruit (e.g., an orange). In order to provide needed shading/texturing/etc. to flesh out the orange's wireframe, a second software thread 126 needs to be executed, either within the same node 104a or, as depicted, a different node 104b. In order to properly execute, second software thread 126 needs to utilize algorithm 120 (which is software for providing additional realistic detail to the orange's wireframe) and/or data 122 (which is used by algorithm 120). In order to access algorithm 120 and/or data 122, second software thread 126 uses pointer 118 in message 110 to point to the location of algorithm 120 and/or data 122 within a storage location (e.g., cache, system memory, a hard drive, etc.) that is associated with NOC 102. Alternatively, algorithm 120 and/or data 122 are part of the payload 116 found in message 110, thus making message 110 larger (and needing more bandwidth to transmit) but more readily accessible to the second software thread 126.

Besides pointing to the algorithm 120 and/or data 122 needed, pointer 118 can point to a pipeline stage that the second software thread 126, algorithm 120 and/or data 122 should be executed within. That is, pointer 118 can point to a particular node (e.g., node 104b), core (e.g., one of multiple cores 106b), and/or hardware thread (e.g., hardware thread 216 shown in FIG. 2) in which the second software thread 126 should be invoked.

Once the second software thread 126 has executed, a new message (not depicted) with a new payload and pointer can be sent to another node or pipeline stage within NOC 102. Such messages continue to be generated in a sequential, cascading manner until the user application 112 completes execution.

Again, note that in one embodiment of the NOC 102 depicted in FIG. 1, each of the nodes 104a-d has exclusive rights to a dedicated respective nanokernel 108a-d. In another embodiment, however, a single nanokernel (not shown) is used to control messages between all of the nodes 104a-d. However, the preferred embodiment uses a different nanokernel with each node in order to provide a more robust architecture, in which each nanokernel can manage messages in a unique prescribed manner.

Note also that data 122 can include hint bits that provide information to the second software thread 126 on how to optimize execution of algorithm 120. For example, continue to assume that algorithm 120 has been pre-compiled. A hint bit (not shown) in data 122 can lock down the most recently used code (that resulted from the algorithm being compiled) in an Instruction Cache (e.g., an L1 I-Cache 618 depicted below in FIG. 6), and pointer 118 can then be pointed to this cache.

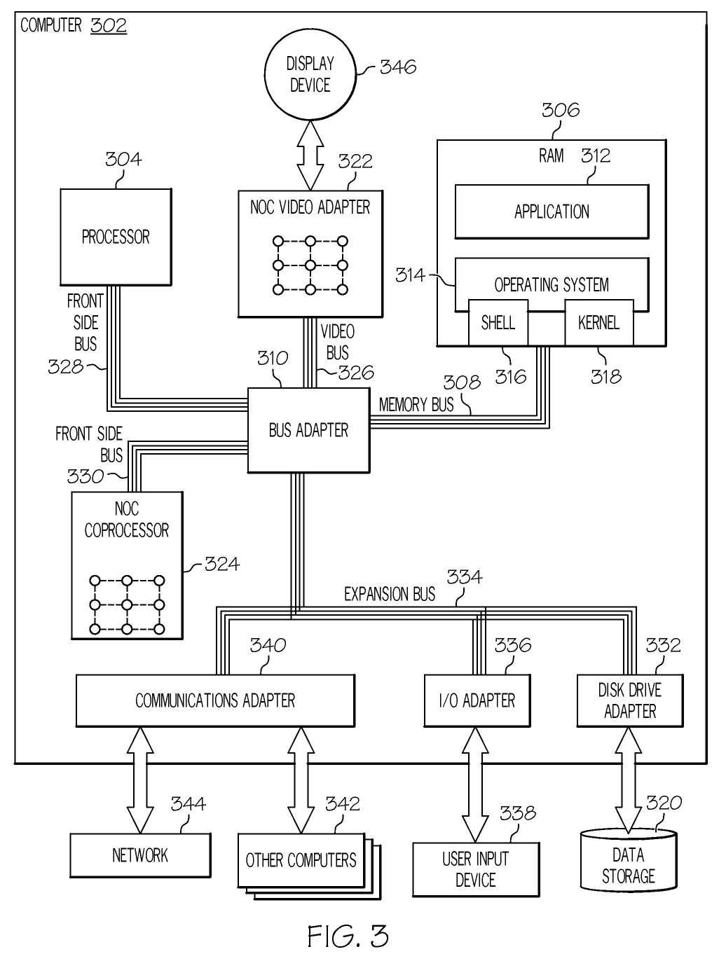

An exemplary apparatus that utilizes a NOC in accordance with the present invention is described at a high level in FIG. 3. As depicted, FIG. 3 sets forth a block diagram of an exemplary computer 302, which is useful in data processing with a NOC according to embodiments of the present invention. Computer 302 includes at least one computer processor 304. Computer 302 also includes a Random Access Memory (RAM) 306, which is system memory that is coupled through a high speed memory bus 308 and bus adapter 310 to processor 304 and to other components of the computer 302.

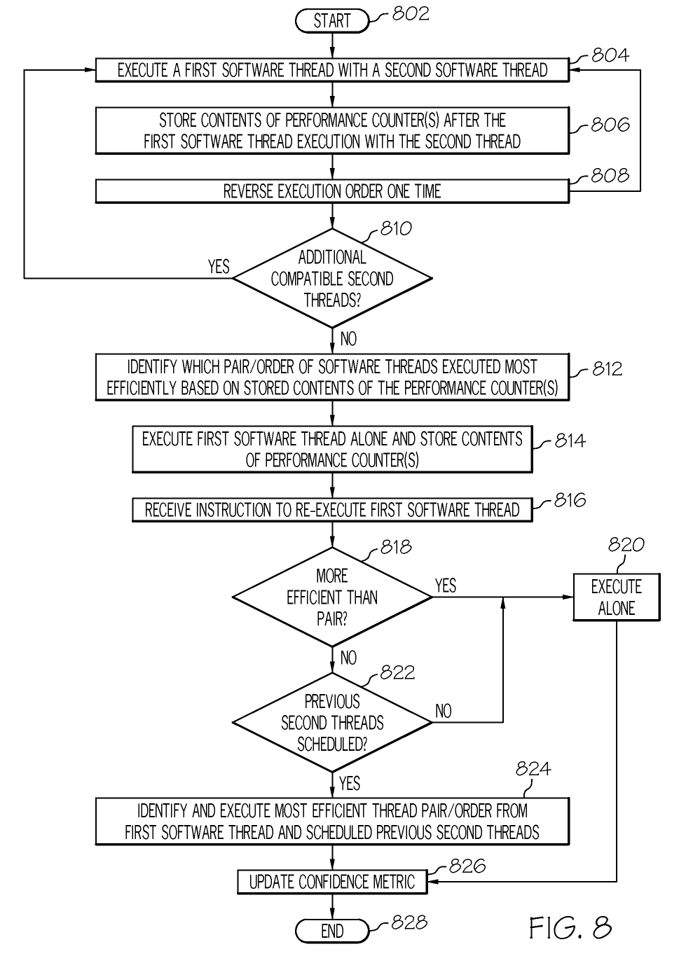

Stored in RAM 306 is an application program 312, which is a module of computer program instructions for carrying out particular data processing tasks such as, for example, word processing, spreadsheets, database operations, video gaming, stock market simulations, atomic quantum process simulations, or other user-level applications. Application program 312 also includes control processes, such as those described above in FIGS. 1-2 and below in FIG. 8. Also stored in RAM 306 is an Operating System (OS) 314. OS 314 includes a shell 316, for providing transparent user access to resources such as application programs 312. Generally, shell 316 is a program that provides an interpreter and an interface between the user and the operating system. More specifically, shell 316 executes commands that are entered into a command line user interface or from a file. Thus, shell 316, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 318) for processing. Note that while shell 316 is a text-based, line-oriented user interface, the present invention will equally well support other user interface modes, such as graphical, voice, gestural, etc.

As depicted, OS 306 also includes kernel 318, which includes lower levels of functionality for OS 306, including providing essential services required by other parts of OS 306 and application programs (e.g., application 312), including memory management, process and task management, disk management, and mouse and keyboard management.

Although operating system 306 and the application 312 in the example of FIG. 3 are shown in RAM 306, such software components may also be stored in non-volatile memory, such as on a disk drive as data storage 320.

The example computer 302 includes two example NOCs according to various embodiments of the present invention: a NOC video adapter 322 and a NOC coprocessor 324. The NOC video adapter 322 is an example of an I/O adapter specially designed for graphic output to a display device 346 such as a display screen or computer monitor. NOC video adapter 322 is connected to processor 304 through a high speed video bus 326, bus adapter 310, and the front side bus 328, which is also a high speed bus.

The example NOC coprocessor 324 is connected to processor 304 through bus adapter 310, and front side bus 328 and front side bus 330, which is also a high speed bus. The NOC coprocessor 324 is optimized to accelerate particular data processing tasks at the behest of the main processor 304.

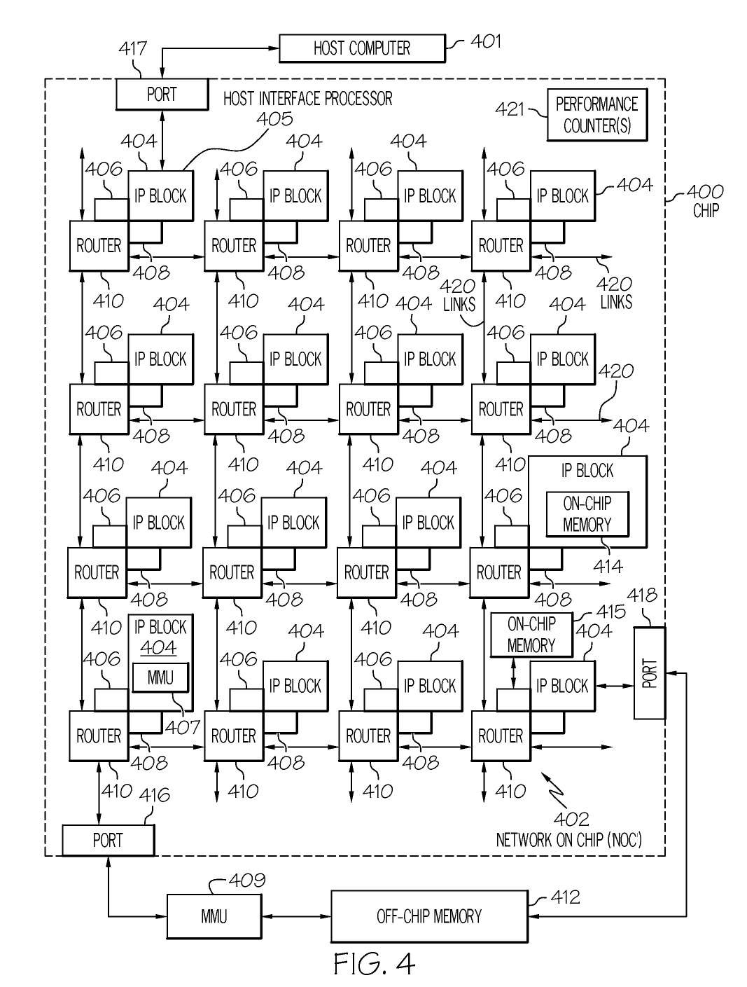

The example NOC video adapter 322 and NOC coprocessor 324 each include a NOC according to embodiments of the present invention, including Integrated Processor (“IP”) blocks, routers, memory communications controllers, and network interface controllers, with each IP block being adapted to a router through a memory communications controller and a network interface controller, each memory communications controller controlling communication between an IP block and memory, and each network interface controller controlling inter-IP block communications through routers. The NOC video adapter 322 and the NOC coprocessor 324 are optimized for programs that use parallel processing and also require fast random access to shared memory. In one embodiment, however, the NOCs described herein and contemplated for use by the present invention utilize only packet data, rather than direct access to shared memory. Again, note that additional details of exemplary NOC architecture as contemplated for use by the present invention are presented below in FIGS. 4-6.

Continuing with FIG. 3, computer 302 may include a disk drive adapter 332 coupled through an expansion bus 334 and bus adapter 310 to processor 304 and other components of computer 302. Disk drive adapter 332 connects non-volatile data storage to the computer 302 in the form of the disk drive represented as data storage 320. Disk drive adapters useful in computers for data processing with a NOC according to embodiments of the present invention include Integrated Drive Electronics (“IDE”) adapters, Small Computer System Interface (“SCSI”) adapters, and others as will occur to those of skill in the art. Non-volatile computer memory also may be implemented such as an optical disk drive, Electrically Erasable Programmable Read-Only Memory (so-called “EEPROM” or “Flash” memory), and so on, as will occur to those of skill in the art.

The example computer 302 also includes one or more input/output (“I/O”) adapters 336. I/O adapter(s) 336 implement user-oriented input/output through, for example, software drivers and computer hardware for controlling output to display devices such as computer display screens, as well as user input from user input devices 338, such as keyboards and mice.

The exemplary computer 302 may also include a communications adapter 340 for data communications with other computers 342, and for data communications with a data communications network 344. Such data communications may be carried out serially through RS-232 connections, through external buses such as a Universal Serial Bus (“USB”), through data communications networks such as IP data communications networks, and in other ways as will occur to those of skill in the art. Communications adapters implement the hardware level of data communications through which one computer sends data communications to another computer, directly or through a data communications network. Examples of communications adapters useful for data processing with a NOC according to embodiments of the present invention include modems for wired dial-up communications, Ethernet (IEEE 802.3) adapters for wired data communications network communications, and IEEE 802.x adapters for wireless data communications network communications.

Note that while NOC video adapter 322 and NOC coprocessor 324 are but two exemplary uses of a NOC, the NOCs and control of work packets described herein may be found in any context in which a NOC is useful for data processing.

With reference now to FIG. 4, a functional block diagram is presented of an exemplary NOC 402 according to embodiments of the present invention. NOC 402 is an exemplary NOC that may be utilized as NOC video adapter 322 and/or NOC coprocessor 324 shown in FIG. 3. NOC 402 is implemented on an integrated circuit chip 400, and is controlled by a host computer 401 (e.g., processor 304 shown in FIG. 3). The NOC 400 includes Integrated Processor (“IP”) blocks 404, routers 410, memory communications controllers 406, and network interface controllers 408. Each IP block 404 is adapted to a router 410 through a dedicated memory communications controller 406 and a dedicated network interface controller 408. Each memory communications controller 406 controls communications between an IP block 404 and memory (e.g., an on-chip memory 414 and/or an off-chip memory 412), and each network interface controller 408 controls inter-IP block communications through routers 410.

In NOC 402, each IP block 404 represents a reusable unit of synchronous or asynchronous logic design used as a building block for data processing within the NOC 402. The term “IP block” is sometimes referred to as an “intellectual property block,” thus designating an IP block 404 as a design that is owned by a party, which is the intellectual property of a party, to be licensed to other users or designers of semiconductor circuits. In the scope of the present invention, however, there is no requirement that IP blocks be subject to any particular ownership, so the term is always expanded in this specification as “integrated processor block.” Thus, IP blocks 404, as specified here, are reusable units of logic, cell, or chip layout design that may or may not be the subject of intellectual property. Furthermore, IP blocks 404 are logic cores that can be formed as Application Specific Integrated Circuit (ASIC) chip designs or Field Programmable Gate Array (FPGA) logic designs.

One way to describe IP blocks by analogy is that IP blocks are for NOC design what a library is for computer programming or a discrete integrated circuit component is for printed circuit board design. In NOCs according to embodiments of the present invention, IP blocks may be implemented as generic gate netlists, as complete special purpose or general purpose microprocessors, or in other ways as may occur to those of skill in the art. A netlist is a Boolean-algebra representation (gates, standard cells) of an IP block's logical-function, analogous to an assembly-code listing for a high-level program application. NOCs also may be implemented, for example, in synthesizable form, described in a hardware description language such as Verilog or VHSIC Hardware Description Language (VHDL). In addition to netlist and synthesizable implementation, NOCs may also be delivered in lower-level, physical descriptions. Analog IP block elements such as a Serializer/Deserializer (SERDES), Phase-Locked Loop (PLL), Digital-to-Analog Converter (DAC), Analog-to-Digital Converter (ADC), and so on, may be distributed in a transistor-layout format such as Graphic Data System II (GDSII). Digital elements of IP blocks are sometimes offered in layout format as well.

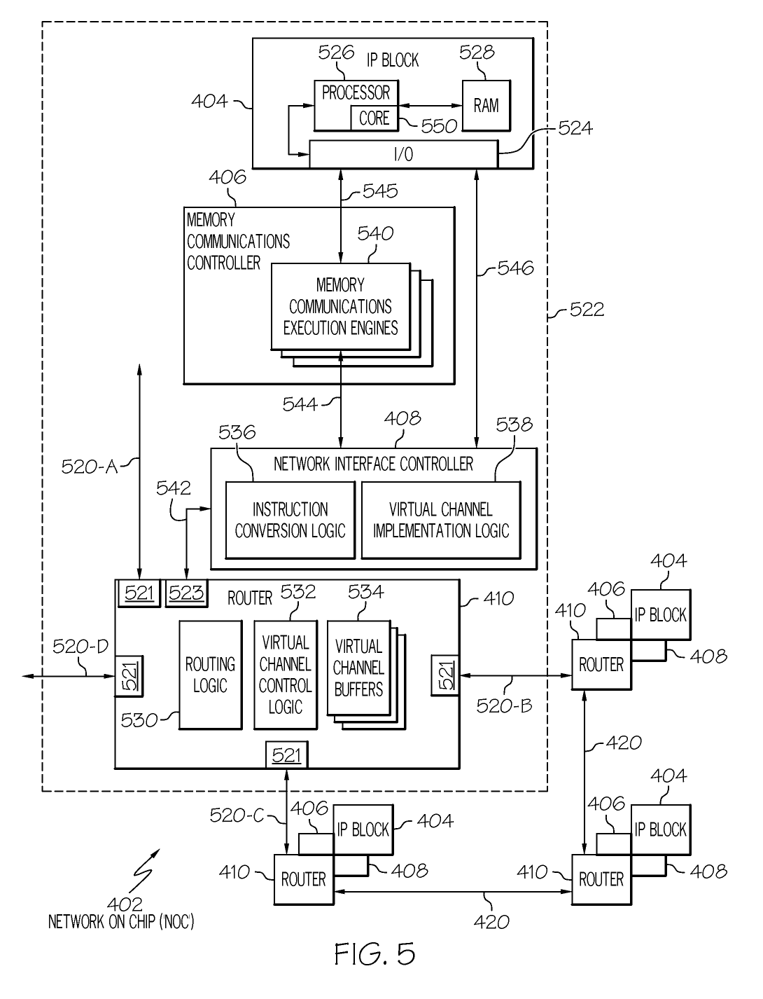

Each IP block 404 shown in FIG. 4 is adapted to a router 410 through a memory communications controller 406. Each memory communications controller is an aggregation of synchronous and asynchronous logic circuitry adapted to provide data communications between an IP block and memory. Examples of such communications between IP blocks and memory include memory load instructions and memory store instructions. The memory communications controllers 406 are described in more detail below in FIG. 5.

Each IP block 404 depicted in FIG. 4 is also adapted to a router 410 through a network interface controller 408. Each network interface controller 408 controls communications through routers 410 between IP blocks 404. Examples of communications between IP blocks include messages (e.g., message/data packets) carrying data and instructions for processing the data among IP blocks in parallel applications and in pipelined applications. The network interface controllers 408 are described in more detail below in FIG. 5.

The routers 410 and links 420 among the routers implement the network operations of the NOC 402 shown in FIG. 4. The links 420 are packet structures implemented on physical, parallel wire buses connecting all the routers. That is, each link is implemented on a wire bus wide enough to accommodate simultaneously an entire data switching packet, including all header information and payload data. If a packet structure includes 64 bytes, for example, including an eight byte header and 56 bytes of payload data, then the wire bus subtending each link is 64 bytes wide, thus requiring 512 wires. In addition, each link 420 is bi-directional, so that if the link packet structure includes 64 bytes, the wire bus actually contains 1024 wires between each router 410 and each of its neighbor routers 410 in the network. A message can include more than one packet, but each packet fits precisely onto the width of the wire bus. If the connection between the router and each section of wire bus is referred to as a port, then each router includes five ports, one for each of four directions of data transmission on the network and a fifth port for adapting the router to a particular IP block through a memory communications controller and a network interface controller.

As stated above, each memory communications controller 406 controls communications between an IP block and memory. Memory can include off-chip main RAM 412, an on-chip memory 415 that is connected directly to an IP block through a memory communications controller 406, on-chip memory enabled as an IP block 414, and on-chip caches. In the NOC 402 shown in FIG. 4, either of the on-chip memories (414, 415), for example, may be implemented as on-chip cache memory. All these forms of memory can be disposed in the same address space, physical addresses or virtual addresses, true even for the memory attached directly to an IP block. Memory addressed messages therefore can be entirely bidirectional with respect to IP blocks, because such memory can be addressed directly from any IP block anywhere on the network. On-chip memory 414 on an IP block can be addressed from that IP block or from any other IP block in the NOC. On-chip memory 415 is attached directly to a memory communication controller, and can be addressed by the IP block that is adapted to the network by that memory communication controller. Note that on-chip memory 415 can also be addressed from any other IP block 404 anywhere in the NOC 402.

Exemplary NOC 402 includes two Memory Management Units (“MMUs”) 407 and 409, illustrating two alternative memory architectures for NOCs according to embodiments of the present invention. MMU 407 is implemented with a specific IP block 404, allowing a processor within that IP block 404 to operate in virtual memory while allowing the entire remaining architecture of the NOC 402 to operate in a physical memory address space. The MMU 409 is implemented off-chip, connected to the NOC through a data communications port referenced as port 416. Port 416 includes the pins and other interconnections required to conduct signals between the NOC 402 and the MMU 409, as well as sufficient intelligence to convert message packets from the NOC packet format to the bus format required by the external MMU 409. The external location of the MMU 409 means that all processors in all IP blocks 404 of the NOC 402 can operate in virtual memory address space, with all conversions to physical addresses of the off-chip memory handled by the off-chip MMU 409.

In addition to the two memory architectures illustrated by use of the MMUs 407 and 409, the data communications port depicted as port 418 illustrates a third memory architecture useful in NOCs according to embodiments of the present invention. Port 418 provides a direct connection between an IP block 404 of the NOC 402 and off-chip memory 412. With no MMU in the processing path, this architecture provides utilization of a physical address space by all the IP blocks of the NOC. In sharing the address space bi-directionally, all the IP blocks of the NOC can access memory in the address space by memory-addressed messages, including loads and stores, directed through the IP block connected directly to the port 418. The port 418 includes the pins and other interconnections required to conduct signals between the NOC and the off-chip memory 412, as well as sufficient intelligence to convert message packets from the NOC packet format to the bus format required by the off-chip memory 412.

In the exemplary NOC 402 shown in FIG. 4, one of the IP blocks 404 is designated a host interface processor 405. A host interface processor 405 provides an interface between the NOC 402 and a host computer 401 (introduced in FIG. 2). Host interface processor 405 provides data processing services to the other IP blocks on the NOC, including, for example, receiving and dispatching among the IP blocks of the NOC data processing requests from the host computer.

Host interface processor 405 is connected to the larger host computer 401 through a data communications port such as port 417. Port 417 includes the pins and other interconnections required to conduct signals between the NOC 402 and the host computer 401, as well as sufficient intelligence to convert message packets from the NOC 402 to the bus format required by the host computer 401. In the example of the NOC coprocessor 324 in the computer 302 shown in FIG. 3, such a port would provide data communications format translation between the link structure of the NOC coprocessor 324 and the protocol required for the front side bus 330 between the NOC coprocessor 324 and the bus adapter 310.

Referring now to FIG. 5, additional detail of NOC 402 is presented according to embodiments of the present invention. As depicted in FIG. 4 and FIG. 5, NOC 402 is implemented on a chip (e.g., chip 400 shown in FIG. 4), and includes integrated processor (“IP”) blocks 404, routers 410, memory communications controllers 406, and network interface controllers 408. Each IP block 404 is adapted to a router 410 through a memory communications controller 406 and a network interface controller 408. Each memory communications controller 406 controls communications between an IP block and memory, and each network interface controller 408 controls inter-IP block communications through routers 410. In the example of FIG. 5, one set 522 of an IP block 404 adapted to a router 410 through a memory communications controller 406 and network interface controller 408 is expanded to aid a more detailed explanation of their structure and operations. All the IP blocks, memory communications controllers, network interface controllers, and routers in the example of FIG. 5 are configured in the same manner as the expanded set 522.

In the example of FIG. 5, each IP block 404 includes a computer processor 526, which includes one or more cores 550, and I/O functionality 524. In this example, computer memory is represented by a segment of Random Access Memory (“RAM”) 528 in each IP block 404. The memory, as described above with reference to the example of FIG. 4, can occupy segments of a physical address space whose contents on each IP block are addressable and accessible from any IP block in the NOC. The processors 526, I/O capabilities 524, and memory (RAM 528) on each IP block effectively implement the IP blocks as generally programmable microcomputers. As explained above, however, in the scope of the present invention, IP blocks generally represent reusable units of synchronous or asynchronous logic used as building blocks for data processing within a NOC. Implementing IP blocks as generally programmable microcomputers, therefore, although a common embodiment useful for purposes of explanation, is not a limitation of the present invention.

In the NOC 402 shown in FIG. 5, each memory communications controller 406 includes a plurality of memory communications execution engines 540. Each memory communications execution engine 540 is enabled to execute memory communications instructions from an IP block 504, including bidirectional memory communications instruction flow (544, 545, 546) between the network interface controller 408 and the IP block 404. The memory communications instructions executed by the memory communications controller may originate, not only from the IP block adapted to a router through a particular memory communications controller, but also from any IP block 404 anywhere in the NOC 402. That is, any IP block 404 in the NOC 402 can generate a memory communications instruction and transmit that memory communications instruction through the routers 410 of the NOC 402 to another memory communications controller associated with another IP block for execution of that memory communications instruction. Such memory communications instructions can include, for example, translation lookaside buffer control instructions, cache control instructions, barrier instructions, and memory load and store instructions.

Each of the depicted memory communications execution engines 540 is enabled to execute a complete memory communications instruction separately and in parallel with other memory communications execution engines 540. The memory communications execution engines 540 implement a scalable memory transaction processor optimized for concurrent throughput of memory communications instructions. The memory communications controller 406 supports multiple memory communications execution engines 540, all of which run concurrently for simultaneous execution of multiple memory communications instructions. A new memory communications instruction is allocated by the memory communications controller 406 to each memory communications execution engine 540, and the memory communications execution engines 540 can accept multiple response events simultaneously. In this example, all of the memory communications execution engines 540 are identical. Scaling the number of memory communications instructions that can be handled simultaneously by a memory communications controller 406, therefore, is implemented by scaling the number of memory communications execution engines 540.

In the NOC 402 depicted in FIG. 5, each network interface controller 408 is enabled to convert communications instructions from command format to network packet format for transmission among the IP blocks 404 through routers 410. The communications instructions are formulated in command format by the IP block 410 or by the memory communications controller 406 and provided to the network interface controller 408 in command format. The command format is a native format that conforms to architectural register files of the IP block 404 and the memory communications controller 406. The network packet format is the format required for transmission through routers 410 of the network. Each such message is composed of one or more network packets. Examples of such communications instructions that are converted from command format to packet format in the network interface controller include memory load instructions and memory store instructions between IP blocks and memory. Such communications instructions may also include communications instructions that send messages among IP blocks carrying data and instructions for processing the data among IP blocks in parallel applications and in pipelined applications.

In the NOC 402 shown in FIG. 5, each IP block 404 is enabled to send memory-address-based communications to and from memory through the IP block's memory communications controller and then also through its network interface controller to the network. A memory-address-based communications is a memory access instruction, such as a load instruction or a store instruction, which is executed by a memory communication execution engine of a memory communications controller of an IP block. Such memory-address-based communications typically originate in an IP block, formulated in command format, and handed off to a memory communications controller for execution.

Many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. All memory-address-based communications that are executed with message traffic are passed from the memory communications controller to an associated network interface controller for conversion (using instruction conversion logic 536) from command format to packet format and transmission through the network in a message. In converting to packet format, the network interface controller also identifies a network address for the packet in dependence upon the memory address or addresses to be accessed by a memory-address-based communication. Memory address based messages are addressed with memory addresses. Each memory address is mapped by the network interface controllers to a network address, typically the network location of a memory communications controller responsible for some range of physical memory addresses. The network location of a memory communications controller 406 is naturally also the network location of that memory communications controller's associated router 410, network interface controller 408, and IP block 404. The instruction conversion logic 536 within each network interface controller is capable of converting memory addresses to network addresses for purposes of transmitting memory-address-based communications through routers of a NOC.

Upon receiving message traffic from routers 410 of the network, each network interface controller 408 inspects each packet for memory instructions. Each packet containing a memory instruction is handed to the memory communications controller 406 associated with the receiving network interface controller, which executes the memory instruction before sending the remaining payload of the packet to the IP block for further processing. In this way, memory contents are always prepared to support data processing by an IP block before the IP block begins execution of instructions from a message that depend upon particular memory content.

Returning now to the NOC 402 as depicted in FIG. 5, each IP block 404 is enabled to bypass its memory communications controller 406 and send inter-IP block, network-addressed communications 546 directly to the network through the IP block's network interface controller 408. Network-addressed communications are messages directed by a network address to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through its I/O functions 524 directly to the IP block's network interface controller in command format, then converted to packet format by the network interface controller and transmitted through routers of the NOC to another IP block. Such network-addressed communications 546 are bi-directional, potentially proceeding to and from each IP block of the NOC, depending on their use in any particular application. Each network interface controller, however, is enabled to both send and receive (communication 542) such communications to and from an associated router, and each network interface controller is enabled to both send and receive (communication 546) such communications directly to and from an associated IP block, bypassing an associated memory communications controller 406.

Each network interface controller 408 in the example of FIG. 5 is also enabled to implement virtual channels on the network, characterizing network packets by type. Each network interface controller 408 includes virtual channel implementation logic 538 that classifies each communication instruction by type and records the type of instruction in a field of the network packet format before handing off the instruction in packet form to a router 410 for transmission on the NOC. Examples of communication instruction types include inter-IP block network-address-based messages, request messages, responses to request messages, invalidate messages directed to caches; memory load and store messages; and responses to memory load messages, and so on.

Each router 410 in the example of FIG. 5 includes routing logic 530, virtual channel control logic 532, and virtual channel buffers 534. The routing logic 530 typically is implemented as a network of synchronous and asynchronous logic that implements a data communications protocol stack for data communication in the network formed by the routers 410, links 420, and bus wires among the routers. The routing logic 530 includes the functionality that readers of skill in the art might associate in off-chip networks with routing tables, routing tables in at least some embodiments being considered too slow and cumbersome for use in a NOC. Routing logic implemented as a network of synchronous and asynchronous logic can be configured to make routing decisions as fast as a single clock cycle. The routing logic in this example routes packets by selecting a port for forwarding each packet received in a router. Each packet contains a network address to which the packet is to be routed. Each router in this example includes five ports, four ports 521 connected through bus wires (520-A, 520-B, 520-C, 520-D) to other routers and a fifth port 523 connecting each router to its associated IP block 404 through a network interface controller 408 and a memory communications controller 406.

In describing memory-address-based communications above, each memory address was described as mapped by network interface controllers to a network address, a network location of a memory communications controller. The network location of a memory communications controller 406 is naturally also the network location of that memory communications controller's associated router 410, network interface controller 408, and IP block 404. In inter-IP block, or network-address-based communications, therefore, it is also typical for application-level data processing to view network addresses as the locations of IP blocks within the network formed by the routers, links, and bus wires of the NOC. Note that FIG. 4 illustrates that one organization of such a network is a mesh of rows and columns in which each network address can be implemented, for example, as either a unique identifier for each set of associated router, IP block, memory communications controller, and network interface controller of the mesh or x, y coordinates of each such set in the mesh.

In the NOC 402 depicted in FIG. 5, each router 410 implements two or more virtual communications channels, where each virtual communications channel is characterized by a communication type. Communication instruction types, and therefore virtual channel types, include those mentioned above: inter-IP block network-address-based messages, request messages, responses to request messages, invalidate messages directed to caches; memory load and store messages; and responses to memory load messages, and so on. In support of virtual channels, each router 410 depicted in FIG. 5 also includes virtual channel control logic 532 and virtual channel buffers 534. The virtual channel control logic 532 examines each received packet for its assigned communications type and places each packet in an outgoing virtual channel buffer for that communications type for transmission through a port to a neighboring router on the NOC.

Each virtual channel buffer 534 has finite storage space. When many packets are received in a short period of time, a virtual channel buffer can fill up—so that no more packets can be put in the buffer. In other protocols, packets arriving on a virtual channel whose buffer is full would be dropped. Each virtual channel buffer 534 in this example, however, is enabled with control signals of the bus wires to advise surrounding routers through the virtual channel control logic to suspend transmission in a virtual channel, that is, suspend transmission of packets of a particular communications type. When one virtual channel is so suspended, all other virtual channels are unaffected—and can continue to operate at full capacity. The control signals are wired all the way back through each router to each router's associated network interface controller 408. Each network interface controller is configured to, upon receipt of such a signal, refuse to accept, from its associated memory communications controller 406 or from its associated IP block 404, communications instructions for the suspended virtual channel. In this way, suspension of a virtual channel affects all the hardware that implements the virtual channel, all the way back up to the originating IP blocks.

One effect of suspending packet transmissions in a virtual channel is that no packets are ever dropped in the architecture of FIG. 5. When a router encounters a situation in which a packet might be dropped in some unreliable protocol such as, for example, the Internet Protocol, the routers in the example of FIG. 5 suspend by their virtual channel buffers 534 and their virtual channel control logic 532 all transmissions of packets in a virtual channel until buffer space is again available, eliminating any need to drop packets. The NOC 402, as depicted in FIG. 5, therefore, implements highly reliable network communications protocols with an extremely thin layer of hardware.

Note that network interface controller 408 and router 410 depicted in FIG. 5 perform the functions of the packet receiving logic 212 and packet redirection logic 216 described above in FIG. 2. In addition, the breakpoint detection logic 214 interfaces with IP block 404 to cause an incoming software packet to single-step as described above.

Referring now to FIG. 6, additional exemplary detail of core 550, originally presented in FIG. 5, is presented. Core 550 includes an on-chip multi-level cache hierarchy including a unified level two (L2) cache 616 and bifurcated level one (L1) instruction (I) and data (D) caches 618 and 620, respectively. As is well-known to those skilled in the art, caches 616, 618 and 620 provide low latency access to cache lines corresponding to memory locations in system memories (e.g., RAM 306 shown in FIG. 3).

Instructions are fetched for processing from L1 I-cache 618 in response to the effective address (EA) residing in instruction fetch address register (IFAR) 630. During each cycle, a new instruction fetch address may be loaded into IFAR 630 from one of three sources: branch prediction unit (BPU) 636, which provides speculative target path and sequential addresses resulting from the prediction of conditional branch instructions, global completion table (GCT) 638, which provides flush and interrupt addresses, and branch execution unit (BEU) 692, which provides non-speculative addresses resulting from the resolution of predicted conditional branch instructions. Associated with BPU 636 is a branch history table (BHT) 635, in which are recorded the resolutions of conditional branch instructions to aid in the prediction of future branch instructions.

An effective address (EA), such as the instruction fetch address within IFAR 630, is the address of data or an instruction generated by a processor. The EA specifies a segment register and offset information within the segment. To access data (including instructions) in memory, the EA is converted to a real address (RA), through one or more levels of translation, associated with the physical location where the data or instructions are stored.

Within core 550, effective-to-real address translation is performed by memory management units (MMUs) and associated address translation facilities. Preferably, a separate MMU is provided for instruction accesses and data accesses. In FIG. 6, a single MMU 611 is illustrated, for purposes of clarity, showing connections only to Instruction Store Unit (ISU) 601. However, it is understood by those skilled in the art that MMU 611 also preferably includes connections (not shown) to load/store units (LSUs) 696 and 698 and other components necessary for managing memory accesses. MMU 611 includes Data Translation Lookaside Buffer (DTLB) 612 and Instruction Translation Lookaside Buffer (ITLB) 613. Each TLB contains recently referenced page table entries, which are accessed to translate EAs to RAs for data (DTLB 612) or instructions (ITLB 613). Recently referenced EA-to-RA translations from ITLB 613 are cached in EOP effective-to-real address table (ERAT) 632.

If hit/miss logic 622 determines, after translation of the EA contained in IFAR 630 by ERAT 632 and lookup of the real address (RA) in I-cache directory 634, that the cache line of instructions corresponding to the EA in IFAR 630 does not reside in L1 I-cache 618, then hit/miss logic 622 provides the RA to L2 cache 616 as a request address via I-cache request bus 624. Such request addresses may also be generated by prefetch logic within L2 cache 616 based upon recent access patterns. In response to a request address, L2 cache 616 outputs a cache line of instructions, which are loaded into prefetch buffer (PB) 628 and L1 I-cache 618 via I-cache reload bus 626, possibly after passing through optional predecode logic 602.

Once the cache line specified by the EA in IFAR 630 resides in L1 cache 618, L1 I-cache 618 outputs the cache line to both branch prediction unit (BPU) 636 and to instruction fetch buffer (IFB) 640. BPU 636 scans the cache line of instructions for branch instructions and predicts the outcome of conditional branch instructions, if any. Following a branch prediction, BPU 636 furnishes a speculative instruction fetch address to IFAR 630, as discussed above, and passes the prediction to branch instruction queue 664 so that the accuracy of the prediction can be determined when the conditional branch instruction is subsequently resolved by branch execution unit 692.

IFB 640 temporarily buffers the cache line of instructions received from L1 I-cache 618 until the cache line of instructions can be translated by instruction translation unit (ITU) 642. In the illustrated embodiment of core 550, ITU 642 translates instructions from user instruction set architecture (UISA) instructions into a possibly different number of internal ISA (IISA) instructions that are directly executable by the execution units of core 550. Such translation may be performed, for example, by reference to microcode stored in a read-only memory (ROM) template. In at least some embodiments, the UISA-to-IISA translation results in a different number of IISA instructions than UISA instructions and/or IISA instructions of different lengths than corresponding UISA instructions. The resultant IISA instructions are then assigned by global completion table 638 to an instruction group, the members of which are permitted to be dispatched and executed out-of-order with respect to one another. Global completion table 638 tracks each instruction group for which execution has yet to be completed by at least one associated EA, which is preferably the EA of the oldest instruction in the instruction group.

Following UISA-to-IISA instruction translation, instructions are dispatched to one of latches 644, 646, 648 and 650, possibly out-of-order, based upon instruction type. That is, branch instructions and other condition register (CR) modifying instructions are dispatched to latch 644, fixed-point and load-store instructions are dispatched to either of latches 646 and 648, and floating-point instructions are dispatched to latch 650. Each instruction requiring a rename register for temporarily storing execution results is then assigned one or more rename registers by the appropriate one of CR mapper 652, link and count (LC) register mapper 654, exception register (XER) mapper 656, general-purpose register (GPR) mapper 658, and floating-point register (FPR) mapper 660.

The dispatched instructions are then temporarily placed in an appropriate one of CR issue queue (CRIQ) 662, branch issue queue (BIQ) 664, fixed-point issue queues (FXIQs) 666 and 668, and floating-point issue queues (FPIQs) 670 and 672. From issue queues 662, 664, 666, 668, 670 and 672, instructions can be issued opportunistically to the execution units of processing unit 603 for execution as long as data dependencies and antidependencies are observed. The instructions, however, are maintained in issue queues 662-672 until execution of the instructions is complete and the result data, if any, are written back, in case any of the instructions need to be reissued.

As illustrated, the execution units of core 550 include a CR unit (CRU) 690 for executing CR-modifying instructions, a branch execution unit (BEU) 692 for executing branch instructions, two fixed-point units (FXUs) 694 and 605 for executing fixed-point instructions, two load-store units (LSUs) 696 and 698 for executing load and store instructions, and two floating-point units (FPUs) 606 and 604 for executing floating-point instructions. Each of execution units 690-604 is preferably implemented as an execution pipeline having a number of pipeline stages.

During execution within one of execution units 690-604, an instruction receives operands, if any, from one or more architected and/or rename registers within a register file coupled to the execution unit. When executing CR-modifying or CR-dependent instructions, CRU 690 and BEU 692 access the CR register file 680, which in a preferred embodiment contains a CR and a number of CR rename registers that each comprise a number of distinct fields formed of one or more bits. Among these fields are LT, GT, and EQ fields that respectively indicate if a value (typically the result or operand of an instruction) is less than zero, greater than zero, or equal to zero. Link and count register (LCR) file 682 contains a count register (CTR), a link register (LR) and rename registers of each, by which BEU 692 may also resolve conditional branches to obtain a path address. General-purpose register files (GPRs) 684 and 686, which are synchronized, duplicate register files and store fixed-point and integer values accessed and produced by FXUs 694 and 605 and LSUs 696 and 698. Floating-point register file (FPR) 688, which like GPRs 684 and 686 may also be implemented as duplicate sets of synchronized registers, contains floating-point values that result from the execution of floating-point instructions by FPUs 606 and 604 and floating-point load instructions by LSUs 696 and 698.

After an execution unit finishes execution of an instruction, the execution notifies GCT 638, which schedules completion of instructions in program order. To complete an instruction executed by one of CRU 690, FXUs 694 and 605 or FPUs 606 and 604, GCT 638 signals the execution unit, which writes back the result data, if any, from the assigned rename register(s) to one or more architected registers within the appropriate register file. The instruction is then removed from the issue queue, and once all instructions within its instruction group have been completed, is removed from GCT 638. Other types of instructions, however, are completed differently.

When BEU 692 resolves a conditional branch instruction and determines the path address of the execution path that should be taken, the path address is compared against the speculative path address predicted by BPU 636. If the path addresses match, no further processing is required. If, however, the calculated path address does not match the predicted path address, BEU 692 supplies the correct path address to IFAR 630. In either event, the branch instruction can then be removed from BIQ 664, and when all other instructions within the same instruction group have completed executing, from GCT 638.

Following execution of a load instruction, the effective address computed by executing the load instruction is translated to a real address by a data ERAT (not illustrated) and then provided to L1 D-cache 620 as a request address. At this point, the load instruction is removed from FXIQ 666 or 668 and placed in load reorder queue (LRQ) 609 until the indicated load is performed. If the request address misses in L1 D-cache 620, the request address is placed in load miss queue (LMQ) 607, from which the requested data is retrieved from L2 cache 616, and failing that, from another core 550 or from system memory (e.g., RAM 528 shown in FIG. 5). LRQ 609 snoops exclusive access requests (e.g., read-with-intent-to-modify), flushes or kills on interconnect fabric (not shown) against loads in flight, and if a hit occurs, cancels and reissues the load instruction. Store instructions are similarly completed utilizing a store queue (STQ) 610 into which effective addresses for stores are loaded following execution of the store instructions. From STQ 610, data can be stored into either or both of L1 D-cache 620 and L2 cache 616.

Note that core 550 has state, which includes stored data, instructions and hardware states at a particular time, and are herein defined as either being “hard” or “soft.” The “hard” state is defined as the information within core 550 that is architecturally required for core 550 to execute a process from its present point in the process. The “soft” state, by contrast, is defined as information within core 550 that would improve efficiency of execution of a process, but is not required to achieve an architecturally correct result. In core 550, the hard state includes the contents of user-level registers, such as CRR 680, LCR 682, GPRs 684 and 686, FPR 688, as well as supervisor level registers 651. The soft state of core 550 includes both “performance-critical” information, such as the contents of L-1 I-cache 618, L-1 D-cache 620, address translation information such as DTLB 612 and ITLB 613, and less critical information, such as BHT 635 and all or part of the content of L2 cache 616. Whenever a software thread (e.g., first software thread 124 and/or second software thread 126) enter or leave core 550, the hard and soft states are respectively populated or restored, either by directly populating the hard/soft states into the stated locations, or by flushing them out entirely using context switching. This state management is preferably performed by the nanokernel (e.g., nanokernels 108a-d described above in FIG. 1).

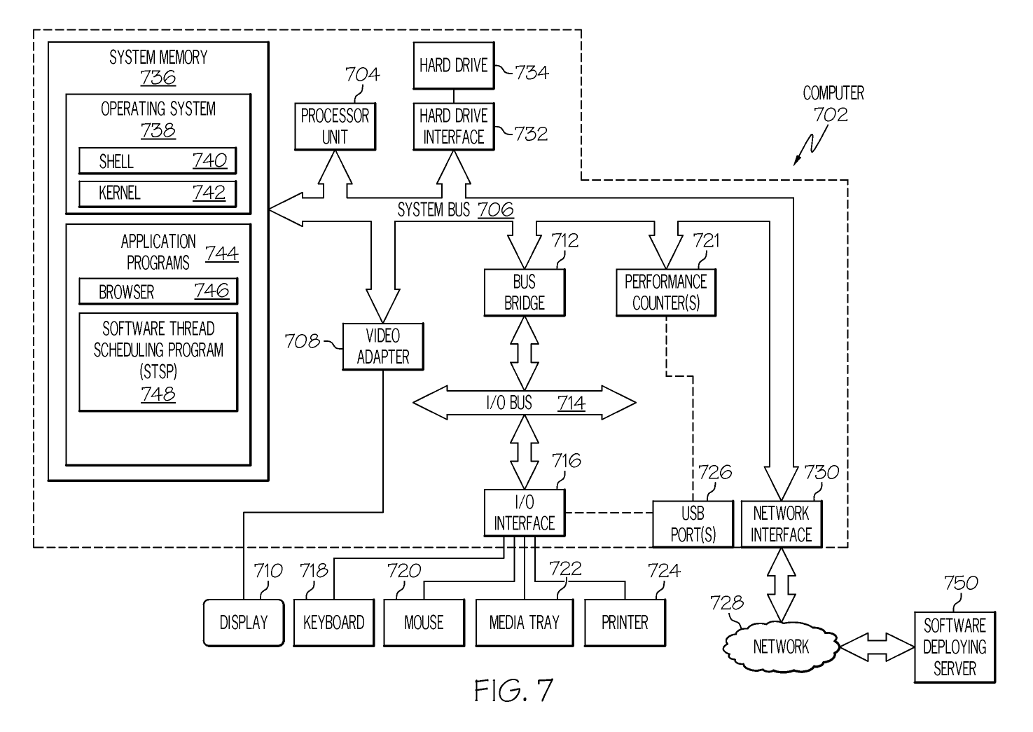

With reference now to FIG. 7, there is depicted a block diagram of an exemplary computer 702, which may be utilized in one embodiment of the present invention. Note that some or all of the exemplary architecture, including both depicted hardware and software, shown for and within computer 702 may be utilized by software deploying server 750.

Computer 702 includes a processing unit 704 that is coupled to a system bus 706. Processing unit 704 may utilize one or more processors, each of which has one or more processor cores. A video adapter 708, which drives/supports a display 710, is also coupled to system bus 706. System bus 706 is coupled via a bus bridge 712 to an input/output (I/O) bus 714. An I/O interface 716 is coupled to I/O bus 714. I/O interface 716 affords communication with various I/O devices, including a keyboard 718, a mouse 720, a media tray 722 (which may include storage devices such as CD-ROM drives, multi-media interfaces, etc.), a printer 724, and external USB port(s) 726. While the format of the ports connected to I/O interface 716 may be any known to those skilled in the art of computer architecture, in one embodiment some or all of these ports are universal serial bus (USB) ports.

As depicted, computer 702 is able to communicate with a software deploying server 750 using a network interface 730. Network 728 may be an external network such as the Internet, or an internal network such as an Ethernet or a virtual private network (VPN).

A hard drive interface 732 is also coupled to system bus 706. Hard drive interface 732 interfaces with a hard drive 734. In one embodiment, hard drive 734 populates a system memory 736, which is also coupled to system bus 706. System memory is defined as a lowest level of volatile memory in computer 702. This volatile memory includes additional higher levels of volatile memory (not shown), including, but not limited to, cache memory, registers and buffers. Data that populates system memory 736 includes computer 702's operating system (OS) 738 and application programs 744.

OS 738 includes a shell 740, for providing transparent user access to resources such as application programs 744. Generally, shell 740 is a program that provides an interpreter and an interface between the user and the operating system. More specifically, shell 740 executes commands that are entered into a command line user interface or from a file. Thus, shell 740, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 742) for processing. Note that while shell 740 is a text-based, line-oriented user interface, the present invention will equally well support other user interface modes, such as graphical, voice, gestural, etc.

As depicted, OS 738 also includes kernel 742, which includes lower levels of functionality for OS 738, including providing essential services required by other parts of OS 738 and application programs 744, including memory management, process and task management, disk management, and mouse and keyboard management.

Application programs 744 include a renderer, shown in exemplary manner as a browser 746. Browser 746 includes program modules and instructions enabling a world wide web (WWW) client (i.e., computer 702) to send and receive network messages to the Internet using hypertext transfer protocol (HTTP) messaging, thus enabling communication with software deploying server 750 and other computer systems.

Application programs 744 in computer 702's system memory (as well as software deploying server 750's system memory) also include a software thread scheduling program (STSP) 748. STSP 748 includes code for implementing the processes described below, including those described in FIG. 8. In one embodiment, computer 702 is able to download STSP 748 from software deploying server 750, including in an on-demand basis, wherein the code in STSP 748 is not downloaded until needed for execution to define and/or implement the improved enterprise architecture described herein. Note further that, in one embodiment of the present invention, software deploying server 750 performs all of the functions associated with the present invention (including execution of STSP 748), thus freeing computer 702 from having to use its own internal computing resources to execute STSP 748.

Note that STSP 748 may also be stored within RAM 306 in FIG. 3 as the application 312, thus providing computer 302 depicted in FIG. 3 with the requisite software for performing the processes described herein.

The hardware elements depicted in computer 702 are not intended to be exhaustive, but rather are representative to highlight essential components required by the present invention. For instance, computer 702 may include alternate memory storage devices such as magnetic cassettes, digital versatile disks (DVDs), Bernoulli cartridges, and the like. These and other variations are intended to be within the spirit and scope of the present invention.

Referring now to FIG. 8, a high-level flow chart of exemplary steps taken to schedule execution of software threads is presented. After initiator block 802, a first software thread is executed together with a second software thread as a first software thread pair (block 804). This simultaneous execution can be through different processors in a multi-processor unit (e.g., processing unit 704 depicted in FIG. 7), in different hardware cores in a multi-core processor (e.g., a multi-core processor in processing unit 704 depicted in FIG. 7), in different hardware threads (as depicted in FIG. 2), or in different IP blocks in a network on a chip (e.g., IP blocks 404 depicted in NOC 402 in FIG. 4).

Each of the first and second software threads may share resources, such as information in a same cache memory, a same system memory, a same persistent memory (e.g., a hard drive), a same register, etc. These shared resources may also be input/output systems/ports/channels, execution units, buffers, etc., all depicted in exemplary manner by various components depicted in FIGS. 1-7. When the software thread pair executes, the impact of usage of such shared resources is stored in at least one performance counter (e.g., performance counter(s) 421 shown in FIG. 4 or performance counter(s) 721 shown in FIG. 7), as described in block 806. For example, the performance counter(s) may store a frequency (how often) successful cache hits occur when two particular software threads run together/simultaneously. In one embodiment, the performance counter(s) store a size of a queue when two particular software threads run together/simultaneously. This queue may be a queue of other processes that depend on a particular software thread or pair; data waiting to be placed on a bus for the particular software thread/pair or for an unrelated software thread/pair; unrelated software threads or pairs that are waiting for execution in a hardware thread, IP unit chain, etc. In one embodiment, the performance counter(s) store how many clock cycles are required for a software thread to access a shared resource.

As described in block 808, the order of execution of the two software threads in the first software thread pair is reversed, such that the second software thread is executed before the first software thread, and the performance parameters of such execution is stored in the performance parameter(s). If there are other software threads that can execute with the first software thread (query block 810), then they are matched with the first software thread to create a second software thread pair for execution (block 804). The second content of the performance counter(s), which resulted from running a first and third software thread together, is then stored (block 806). The process continues in a reiterative manner until no additional software threads are identified for joint execution with the first software thread.

As described in block 812, a most efficient software thread pair is then identified from all pairings of the first software thread with other software threads, executing in either order, based on the content of the performance counter(s). That is, the most efficient software thread pairing is determined based on which permutation of two software threads (the first software thread and some other software thread) running in a particular order (the first software thread executing before the other software thread or vice versa) is most efficient, according to the contents of the performance counter(s).

As described in block 814, the first software thread is then executed alone (without any other software thread being simultaneously executed within a processor core, etc.). The impact on hardware resources from executing the first software thread alone is then stored in the performance counter(s).

As described in block 816, a request is then received (e.g., from a scheduler, an operating system, an ERAT, etc.) to re-execute the first software thread. A determination is first made as to whether the first software thread should run alone (query block 818). For example, based on the stored contents of the performance counter(s) during single-thread or paired-thread executions, a determination may be made that all software thread pairings with the first software thread fail to execute at a predefined level of efficiency. If so, then the first software thread will execute alone (block 820), assuming that this does not cause too great a tie-up of resources in the core (per some predefined level of thrashing/delay/etc.). However, if the first software thread can execute efficiently with another software thread, then the most efficient pairing, based on previous pairings and executions, is identified. If such other software threads are available and scheduled for execution (query block 822), then they are matched with the first software thread for simultaneous execution with the first software thread (block 824). In one embodiment, this matching is made with whichever other software thread has been shown, during past executions, to provide the most efficient pairing, as compared with pairings of other software threads with the first software thread.

Note that in one embodiment, if known other software threads are not available to run with the first software thread, and running the first software thread alone would inordinately tie up resources in the processor/core, then another available software thread, which has not run with the first software thread before, is enlisted to run simultaneously with the first software thread. This other available software thread need only pass some minimal threshold of matching certain predefined characteristics of previously paired software threads. For example, assume that the first software thread had been previously matched with a second software thread, and that the first software thread ran on a load/store unit within a core, while the second software thread ran on a floating point execution unit within the core. If those first and second software threads ran simultaneously in an efficient manner, then an assumption is made that the first software thread can be paired up with any available software thread that runs on the floating point execution unit within the core. Similarly, if the first software thread ran efficiently when paired with a second software thread that ran on some particular core/processor (the same or another as that on which the first software thread is running), then the first software thread can be matched with any other software thread that runs on the particular core/processor on which the second software thread ran.

Continuing with block 824, a determination can be made as to whether execution of a pairing of first and second software threads, execution of a pairing of first and third software threads, execution of a reverse order of the first and second software threads, execution of a reverse order of the first and third software threads, or execution of just the first software thread (without any pairing) is most efficient. Whichever execution has been shown to be the most efficient in the past (based on the contents of the performance counter(s)) will be performed in block 824.

Note that each time the first software thread executes (either alone or simultaneously with another software thread), a content table containing content from the performance counter(s) is updated with revised content. Using this revised content, a process table (used to switch out threads within a processor) can then refine how it assigns software threads to specific hardware threads for execution in a processor core. That is, the process table saves state information about a process, memory, resources, etc. in order to swap out one process with another in a multi-processing core. In one embodiment, if the revised/updated content should fall below some predetermined minimum level (indicating that executing pairs of software threads is too inefficient), then the first software thread is run alone without being paired to any other software thread.

Note that in one embodiment, the matching of software threads is based on one thread running on a different execution unit in a processor core than another software thread. For example, if the first software thread runs on FXU 694 shown in FIG. 6, while the second software thread runs on LSU 698 in FIG. 6, then they may be a good pairing match. In one embodiment, if two software threads use data from a same cache memory (e.g., L1 D-cache 620 shown in FIG. 6), then they may not make a good pair for co-execution, since one will be waiting on the other to access the same cache memory. Similarly, if two software threads share a general purpose register (e.g., GPR 684 shown in FIG. 6), they likewise would not be a good pair for co-execution.

Returning to FIG. 8, the information from the performance counter(s) can then be used to construct a confidence metric. This confidence metric describes how efficiently different software thread pairs work together. Upon each re-execution of the first software thread with or without another software thread, this confidence metric is updated (block 826). This updating can occur until some predetermined timeout, or it can stop and start, in order to conserve processing resources that are required to update the confidence metric. The process ends at terminator block 828.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer-implemented method of scheduling execution of software threads, the computer implemented method comprising:
executing a first software thread together with a second software thread as a first software thread pair;
storing a first content of at least one performance counter, wherein the first content of said at least one performance counter resulted from executing the first software pair together;
executing the first software thread together with a third software thread as a second software thread pair;
storing a second content of said at least one performance counter, wherein the second content of said at least one performance counter resulted from executing the second software thread pair;
identifying a most efficient software thread pair based on whether the first software thread pair or the second software thread pair executed more efficiently, as determined by the first content and the second content of said at least one performance counter;
receiving a request to re-execute the first software thread; and
selectively matching the first software thread with either the second software thread or the third software thread for execution based on whether the first software thread pair or the second software thread pair has been identified to execute more efficiently based on the first content and the second content of said at least one performance counter.

2. The computer implemented method of claim 1, wherein the first software thread pair containing the second software thread has been identified as executing more efficiently than the second software thread pair containing the third software thread, the computer implemented method further comprising:
in response to the second software thread and the third software thread not being available for execution with the first software thread, matching a fourth software thread with the first software thread for execution, wherein the fourth software thread has been predetermined to match predefined characteristics of the second software thread.

3. The computer implemented method of claim 1, further comprising:
determining that the first software thread pair and the second software thread pair both fail to execute at a predefined level of efficiency based on the first content and the second content of said at least one performance counter; and
in response to receiving the first software thread for re-execution, executing the first software thread alone without being paired to any other software thread.

4. The computer implemented method of claim 1, further comprising:
reversing an order of execution for the first software thread together with the second software thread as a reversed first software pair;
storing a third content of said at least one performance counter, wherein the third content resulted from executing the reversed first software pair together; and
selectively running either the first software thread pair, the second software thread pair, or the reversed first software pair based on the first content, the second content, and the third content of said at least one performance counter.

5. The computer implemented method of claim 1, further comprising:
storing the first content of said at least one performance counter in a content table; and
in response to the first software thread pair re-executing, updating the content table with a revised first content that resulted from the first software thread pair re-executing to create an updated content table.

6. The computer implemented method of claim 5, further comprising:
creating a process table based on the updated content table, wherein the process table assigns execution of software threads to specific hardware threads in a processor core.

7. The computer implemented method of claim 5, further comprising:
in response to contents of the updated content table for the first software thread pair falling below a predetermined minimum level that indicates a predefined level of inefficiency of execution, restricting execution of the first software thread such that the first software thread is not paired with any other software thread for simultaneous execution.

8. The computer implemented method of claim 1, wherein said at least one performance counter stores a frequency of successful cache hits when two software threads execute together.

9. The computer implemented method of claim 1, wherein said at least one performance counter stores a size of a queue within a processor when two software threads execute together.

10. The computer implemented method of claim 1, further comprising:
selectively matching the first software thread with the second software thread based on the first software thread utilizing a different execution unit within a processor core than the second software thread.

11. The computer implemented method of claim 1, further comprising:
selectively matching the first software thread with the second software thread based on the first software thread and the second software thread not utilizing a same cache memory at different times.

12. The computer implemented method of claim 1, further comprising:
selectively matching the first software thread with the second software thread based on the first software thread and the second software thread not utilizing data from a same general purpose register in a processor core.

13. A computer program product for scheduling execution of software threads, the computer program product comprising:
a computer readable storage media;
first program instructions to execute a first software thread together with a second software thread as a first software thread pair;
second program instructions to store a first content of at least one performance counter, wherein the first content of said at least one performance counter resulted from executing the first software pair together;
third program instructions to execute the first software thread together with a third software thread as a second software thread pair;
fourth program instructions to store a second content of said at least one performance counter, wherein the second content of said at least one performance counter resulted from executing the second software thread pair;
fifth program instructions to identify a most efficient software thread pair based on whether the first software thread pair or the second software thread pair executed more efficiently, as determined by the first content and the second content of said at least one performance counter;
sixth program instructions to receive a request to re-execute the first software thread; and
seventh program instructions to selectively match the first software thread with either the second software thread or the third software thread for execution based on whether the first software thread pair or the second software thread pair has been identified to execute more efficiently based on the first content and the second content of said at least one performance counter; and wherein
the first, second, third, fourth, fifth, sixth, and seventh program instructions are stored on the computer readable storage media.

14. The computer program product of claim 13, wherein the first software thread pair containing the second software thread has been identified as executing more efficiently than the second software thread pair containing the third software thread, and wherein the computer program product further comprises:
eighth program instructions to, in response to the second software thread and the third software thread not being available for execution with the first software thread, match a fourth software thread with the first software thread for execution, wherein the fourth software thread has been predetermined to match predefined characteristics of the second software thread; and wherein
the eighth program instructions are stored on the computer readable storage media.

15. The computer program product of claim 13, further comprising:
eighth program instructions to determine that the first software thread pair and the second software thread pair both fail to execute at a predefined level of efficiency based on the first content and the second content of said at least one performance counter; and
ninth program instructions to, in response to receiving the first software thread for re-execution, execute the first software thread alone without being paired to any other software thread; and wherein
the eighth and ninth program instructions are stored on the computer readable storage media.

16. The computer program product of claim 13, further comprising:
eighth program instructions to reverse an order of execution for the first software thread together with the second software thread as a reversed first software pair;
ninth program instructions to store a third content of said at least one performance counter, wherein the third content resulted from executing the reversed first software pair together; and
tenth program instructions to selectively run either the first software thread pair, the second software thread pair, or the reversed first software pair based on the first content, the second content, and the third content of said at least one performance counter; and wherein the eighth, ninth, and tenth program instructions are stored on the computer readable storage media.

17. A computer system comprising:
a processor, a computer readable memory, and a computer readable storage media;
first program instructions to execute a first software thread together with a second software thread as a first software thread pair;
second program instructions to store a first content of at least one performance counter, wherein the first content of said at least one performance counter resulted from executing the first software pair together;
third program instructions to execute the first software thread together with a third software thread as a second software thread pair;
fourth program instructions to store a second content of said at least one performance counter, wherein the second content of said at least one performance counter resulted from executing the second software thread pair;
fifth program instructions to identify a most efficient software thread pair based on whether the first software thread pair or the second software thread pair executed more efficiently, as determined by the first content and the second content of said at least one performance counter;
sixth program instructions to receive a request to re-execute the first software thread; and
seventh program instructions to selectively match the first software thread with either the second software thread or the third software thread for execution based on whether the first software thread pair or the second software thread pair has been identified to execute more efficiently based on the first content and the second content of said at least one performance counter; and wherein
the first, second, third, fourth, fifth, sixth, and seventh program instructions are stored on the computer readable storage media for execution by the processor via the computer readable memory.

18. The computer system of claim 17, wherein the first software thread pair containing the second software thread has been identified as executing more efficiently than the second software thread pair containing the third software thread, and wherein the computer system further comprises:
eighth program instructions to, in response to the second software thread and the third software thread not being available for execution with the first software thread, match a fourth software thread with the first software thread for execution, wherein the fourth software thread has been predetermined to match predefined characteristics of the second software thread; and wherein
the eighth program instructions are stored on the computer readable storage media for execution by the processor via the computer readable memory.

19. The computer system of claim 17, further comprising:
eighth program instructions to determine that the first software thread pair and the second software thread pair both fail to execute at a predefined level of efficiency based on the first content and the second content of said at least one performance counter; and
ninth program instructions to, in response to receiving the first software thread for re-execution, execute the first software thread alone without being paired to any other software thread; and wherein
the eighth and ninth program instructions are stored on the computer readable storage media for execution by the processor via the computer readable memory.

20. The computer system of claim 17, further comprising:
eighth program instructions to reverse an order of execution for the first software thread together with the second software thread as a reversed first software pair;
ninth program instructions to store a third content of said at least one performance counter, wherein the third content resulted from executing the reversed first software pair together; and
tenth program instructions to selectively run either the first software thread pair, the second software thread pair, or the reversed first software pair based on the first content, the second content, and the third content of said at least one performance counter; and wherein the eighth, ninth, and tenth program instructions are stored on the computer readable storage media for execution by the processor via the computer readable memory.
